(19) United States
(12) Patent Application Publication
(10) Pub. No.: US 2007/0229460 A1
(43) Pub. Date: Oct. 4, 2007

(54) Pointing device, and method of displaying remaining battery power thereof

(75) Inventors: Osamu Yamazaki, Tokyo (JP); Hidekazu Aizawa, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/730,076

(22) Filed: Mar. 29, 2007

(30) Foreign Application Priority Data
Mar. 29, 2006 (JP) 2006-089930

(51) Int. Cl. G09G 5/08

(52) U.S. Cl. 345/163

(57) ABSTRACT

According to one embodiment, a wireless device includes an optical motion detector, battery lifetime display unit, battery, communication unit, communication signal emitting opening, and mouse button unit. The optical motion detector includes a CPU, RAM, ROM, and optical unit. The optical unit has a light emitting unit configured to emit light from an opening toward a plate or desktop upon which the wireless device is placed, a lens for collecting the light reflected therefrom, and a CMOS image sensor for receiving the collected light and detecting patterns on the plate or desktop. The battery lifetime display unit includes the CPU, RAM, ROM, light emitting unit, and a voltage detection circuit. The battery lifetime display unit allows the user to know whether the battery thereof has reached its lifetime, that is to say, whether the voltage of the battery has dropped so low that the wireless device cannot function.

### CROSS-REFERENCE TO RELATED APPLICATIONS

This application claims the benefit of priority of Japanese Patent Application No. 2006-089930, filed Mar. 29, 2006, the entire contents of which are incorporated herein by reference.

### BACKGROUND

1. Field

The present invention relates to a pointing device which is used as an input device for electronic equipment such as personal computers and the like, and a method of displaying the remaining battery power of the pointing device.

2. Description of the Related Art

There are some mice (pointing devices) and keyboards used as input devices for electronic equipment such as personal computers and the like which have wireless functions. Wireless device having such wireless functions use batteries as the electric power source thereof.

A known example of remaining battery power displaying of such a wireless device is a wireless pointing device battery-low warning device disclosed in Japanese Unexamined Patent Application Publication No. 2003-241895.

This wireless pointing device battery-low warning device includes warning signal reception means for receiving the battery-low warning signals from the wireless pointing device, and an electronic equipment main unit having warning means for giving battery-low warnings in accordance with the contents of the received battery-low warning signals. The warning means display a warning using a display device provided to the electronic equipment main unit, or display a warning on a display screen by way of the operating system of the electronic equipment main unit, and thereby can notify a user to the effect that the battery of the wireless pointing device is nearly dead, or too low for the wireless pointing device to function.

With remaining battery power display techniques with conventional wireless devices, the battery-low warning display is made at a display unit or display screen provided to the electronic equipment main unit, so the user cannot obtaining information regarding the battery lifetime of the wireless device while the power of the electronic equipment main unit is off. Accordingly, the user cannot readily know the battery lifetime of the wireless device.

### SUMMARY OF THE INVENTION

The present invention has been made in light of the above situation, and accordingly it is an object of the present invention to provide a pointing device, and a method of displaying the remaining battery power of the pointing device, whereby the remaining battery lifetime of the pointing device can be readily known by the user.

To solve the above problem, the pointing device according to one aspect of the present invention is a pointing device for controlling movement of a pointer displayed on a display unit of an information processing device, includes an emitting unit configured to emit light for controlling the movement of the pointer; a battery; and a control unit configured to control emission of light from the emitting unit with a first control method in an event that the remaining power of the battery exceeds a predetermined remaining amount, and to control emission of light from the emitting unit with a second control method in an event that the remaining power of the battery is below the predetermined remaining amount.

Further, to solve the above problem, the pointing device according to another aspect of the present invention is a pointing device for controlling movement of a pointer displayed on a display unit of an information processing device, includes an emitting unit configured to emit light for controlling the movement of the pointer; a communication unit configured to transmit, to the information processing device, signals indicating a movement amount of the pointer calculated based on the emitted light from the emitting unit; a battery; and a control unit configured to control emission of light from the emitting unit with a first control method in an event that a remaining power of the battery is such that signals are transmitted from the communication unit to the information processing device, and controlling emission of light from the emitting unit with a second control method in an event that the remaining power of the battery is such that the signals are not transmitted from the communication unit to the information processing device.

Further more, to solve the above problem, the battery remaining power display method according to further aspect of the present invention is a battery remaining power display method of a pointing device having an emitting unit configured to emit light to control movement of a pointer displayed on a display unit of an information processing device, the method includes the steps of: determining a remaining power of a battery of the pointing device; controlling emission of light from the emitting unit with a first control method in an event that determination is made in the determination step that the remaining power of the battery exceeds a predetermined remaining amount; and controlling emission of light from the emitting unit with a second control method in an event that determination is made in the determination step that the remaining power of the battery is below the predetermined remaining amount.

With the pointing device, and a method of displaying the remaining battery power of the pointing device, according to the present invention, the remaining battery lifetime of the pointing device can be readily known by the user.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic external perspective view illustrating a wireless device according to an embodiment of the present invention;

FIG. 2 is a schematic overall configuration diagram of the wireless device shown in FIG. 1; and

FIG. 3 is a flowchart illustrating the procedures for displaying the remaining battery lifetime with the wireless device shown in FIG. 1, by way of a battery lifetime display unit provided to the wireless device.

### DETAILED DESCRIPTION

Hereinbelow, a description will be given of a pointing device, and a method of displaying the remaining battery power of the pointing device, according to an embodiment of the present invention with reference to the drawings.

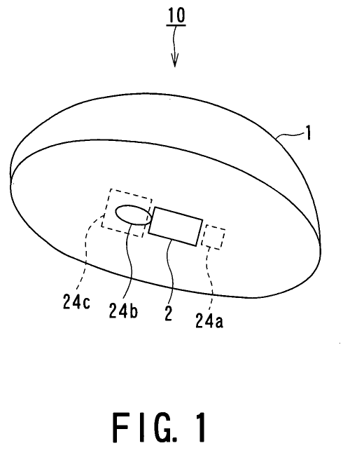

FIG. 1 is a schematic external perspective view illustrating a wireless device according to an embodiment of the present invention. Note that with the present embodiment, an optical wireless mouse will be used as an example of a wireless device such as a pointing device or the like.

A wireless device 10 has an opening 2 on one outer face of a housing 1. A light-emitting unit 24 is provided within the housing 1, nearby the opening 2. A lens 24b is provided near the opening 2, with a CMOS image sensor 24c being provided at a suitable position on the side of the lens 24b toward the inside of the housing 1. This position is such that the CMOS image sensor 24c can sufficiently receive the light collected by the lens 24b so as to be able to perform image analysis based on the light.

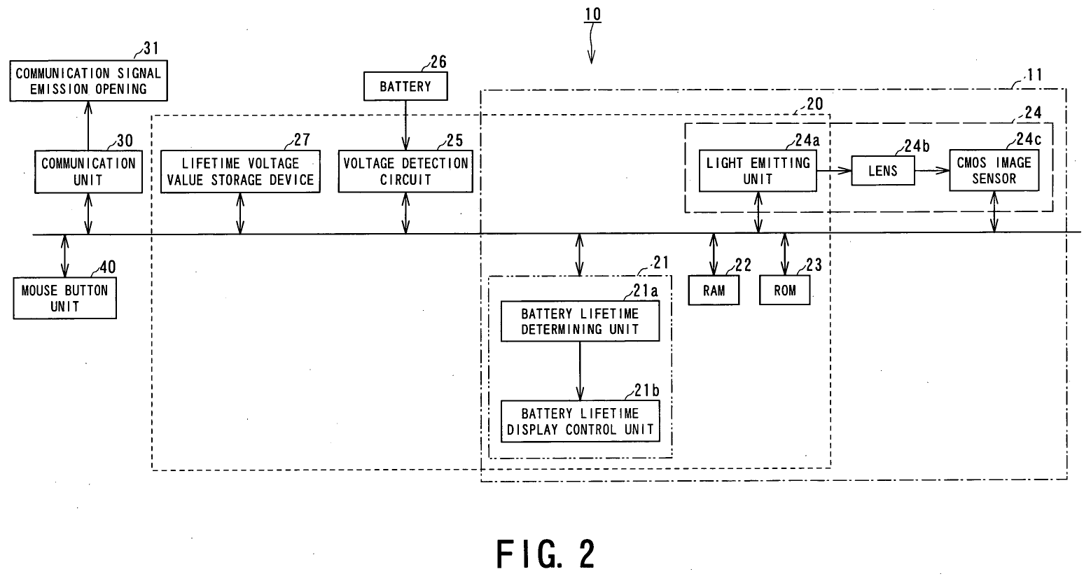

FIG. 2 is a schematic overall configuration diagram of the wireless device 10 shown in FIG. 1. The wireless device 10 has an optical motion detector 11, battery lifetime display control unit 20 (control unit) for displaying the state of the battery remaining power (battery voltage), a battery 26, communication unit 30, communication signal emission opening 31, and a mouse button unit 40.

The optical motion detector 11 has a CPU 21, RAM 22, ROM 23, and optical unit 24. The optical unit 24 has the light-emitting unit 24a for emitting light such as LED, laser, or the like, via the opening 2, toward a plate, desktop, etc., upon which the wireless device 10 has been placed, the lens 24b for collecting the light reflected from the plate, desktop, etc., and the CMOS image sensor 24c for receiving the collected light and detecting patterns of the plate, desktop, etc.

Various types of optical motion detectors are known, and a suitable one of these can be used for the optical motion detector 11.

The battery lifetime display control unit 20 has the CPU 21, RAM 22, ROM 23, light-emitting unit 24a, a voltage detection circuit 25, and lifetime voltage value storage device 27.

The CPU 21 controls the operation of the optical motion detector 11 following a program stored in the ROM 23. The CPU 21 loads a motion detection program stored in the ROM 23 and data necessary for executing the program to the RAM 22, and executes processing for detecting the amount of motion and the direction of motion of the wireless device 10, following by the motion detection program.

The CPU 21 follows a program stored in the ROM 23 to control the operation of the battery lifetime display control unit 20. The CPU 21 loads the battery lifetime detection program stored in the ROM 23 and data necessary for executing the program to the RAM 22, and executes processing for performing battery lifetime display for the wireless device 10 by way of the battery lifetime display unit 20, following the battery lifetime detection program.

The RAM 22 provides a work area for temporarily storing the programs and data executed by the CPU 21.

The ROM 23 stores the motion detection program, battery lifetime display program, and various types of data for executing these programs.

Note that the ROM 23 has a configuration including a storage medium which is readable by the CPU 21, such as magnetic or optical storage medium or semiconductor memory or the like, and may be configured so as to download part or all of the programs and data within the ROM 23 via an electronic network, or may be configured so as to receive these from anelectronic equipment main unit, such as a personal computer.

The voltage detection circuit 25 monitors the voltage of the battery 26, and provides values of this voltage to the CPU 21.

The battery 26 is the power source of the wireless device 10, and handles driving of the optical motion detector 11 and communication unit 30. The battery 26 may either be a primary cell or a rechargeable secondary cell. The lifetime voltage value storage device 27 store the lifetime voltage value of the battery 26 beforehand.

The communication unit 30 converts detection signals from the optical motion detector 11 and output signals from the mouse button unit 40 into infrared signals or radio signals, and externally emits the signals from the communication signal emission opening 31. The communication unit 30 and the communication signal emission opening 31 may be such that are used with wireless mice in general.

The mouse button unit 40 is configured of one or multiple buttons as with the mouse button unit of wireless mice in general, with the intent of the user being communicated to the electronic equipment main unit by operations thereof. Further, a button thereof may include a wheel button.

The CPU 21 functions as at least a battery lifetime determining unit 21a and a battery lifetime display unit 21b, in accordance with the battery lifetime detection program stored in the ROM 23. These units use a predetermined work area of the RAM 22 as temporary storage for data. Note that these units may be configured of hardware logic without using the CPU 21.

The battery lifetime determining unit 21a functions to receive the voltage value of the battery 26 from the voltage detecting circuit 25, and determines whether or not this voltage value is lower than the lifetime voltage value stored in the lifetime voltage value storage device 27 beforehand.

Now, this lifetime voltage value may be a voltage value necessary for driving the communication unit 30, for example. The battery 26 would be determined to be too low when the wireless device 10 cannot be driven, i.e., at the point that the voltage value drops below the voltage value necessary for driving the wireless device 10. Generally, the communication unit 30 needs the highest driving voltage of the components of the wireless device 10, with the necessary driving voltage value of the communication unit 30 being higher than the necessary driving voltage value of the optical motion detector 11. Accordingly, setting the necessary driving voltage value of the communication unit 30 as the lifetime voltage value is a suitable arrangement.

The battery lifetime display unit 21b functions to receive information from the battery lifetime determining unit 21a to the effect that the voltage value of the battery 26 has dropped below the lifetime voltage value, and controls the state of light which the light emitting unit 24a emits so as to blink for example (repetition of one second on, two seconds off, or the like).

Note that control of the lit state only needs to be such that can tell the user that the battery has reached the end of its life. The light emitted from the light emitting unit 24a normally turns on and off hundreds or thousands of times each second, and accordingly appears to be steadily on to the naked eye. Accordingly, the light emitted by the light emitting unit 24a may be made to blink at a sufficiently long cycle (repetition of one second on, two seconds off, or the like), or to completely turn off, or to be lit but at a lower power.

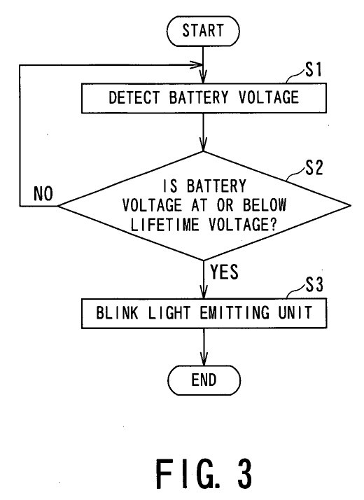

Next, the operations of the wireless device 10 will be described. FIG. 3 is a flowchart illustrating the procedures for displaying the remaining battery lifetime with the wireless device 10 with the battery lifetime display control unit 20 thereof. The reference numerals with the letter S indicate the steps in the flowchart.

With the flowchart shown in FIG. 3, the lifetime voltage value is stored in the lifetime voltage value storage device 27 beforehand, the flow start upon the battery 26 being connected to the wireless device 10 and the power of the wireless device 10 turning on, and the flow proceeds to step S1.

The following description will be made with an example wherein the initial voltage of the battery 26 is 1.5 V, and the lifetime voltage value stored in the lifetime voltage value storage device 27 beforehand is 1.2 V.

First, in step S1, the voltage detecting circuit 25 monitors the voltage of the battery 26, and provides this voltage value to the battery lifetime determining unit 21a.

Next, in step S2, the battery lifetime determining unit 21a determines whether or not the voltage value of the battery 26 received from the voltage detecting circuit 25 is below the lifetime voltage value 1.2 V stored in the battery lifetime determining unit 21a beforehand. In the event that the current value is above 1.2 V, the flow returns to step S1. Otherwise, i.e., in the event that the value is 1.2 V or lower, the flow proceeds to step S3.

Next, in step S3, the battery lifetime display unit 21b receives information from the battery lifetime determining unit 21a to the effect that the voltage value of the battery 26 has dropped below the lifetime voltage value 1.2 V, and controls the lit state of the light which the light emitting unit 24a emit so as to blink in repetition of one second on and two seconds off.

According to the above procedures, the battery lifetime can be displayed by the battery lifetime display control unit 20 of the wireless device 10.

The wireless device 10 shown in FIG. 1 notifies the user of the battery lifetime by way of the light emitting unit 24a. Accordingly, the user can readily know that the battery lifetime has run out for the battery 26 in the wireless device 10, without having to involve the electronic equipment such as a personal computer.

Optical mice having optical motion detectors generally have the light emitting unit 24a, so this wireless device 10 can be configured using components of already-existing optical mice, except for the voltage detecting circuit 25, which is advantageous from an industrial manufacturing perspective.

Generally, the communication unit 30 needs the highest driving voltage of the components of the wireless device 10, with the necessary driving voltage value of the communication unit 30 being higher than the necessary driving voltage value of the optical motion detector 11. Accordingly, there is an intermediate state for the voltage of the battery 26, wherein the voltage is lower than the necessary driving voltage value of the communication unit 30, but is at or above the necessary driving voltage value of the optical motion detector 11.

In this intermediate state, the communication 30 cannot be driven, so no communication can be made between the wireless device 10 and the electronic equipment main unit, and the wireless device 10 cannot be used to move a pointer, for example, on an electronic equipment display device, such as a CRT or LCD for example. Still, the optical motion detector 11 is operable, so the user can visually recognize the light emitted from the light emitting unit 24a of the wireless device 10.

In this intermediate state of the battery 26, the user can see the light emitted from the light emitting unit 24a but the pointer or the like on the screen is inoperable, so the user is clueless regarding whether the battery is low or whether some other sort of malfunction has befallen the wireless device 10, leading to unnecessary confusion on the part of the user. However, with this wireless device 10, the lit state of the light which the light emitting unit 24a emits can be used as a display to the effect that the battery has reached its lifetime by blinking, turning on and off, etc. Accordingly, the user can be readily notified to that effect in the intermediate state of the battery 26, without being confused.

Also, at the point that the voltage of the battery 26 drops below the necessary driving voltage value of the communication unit 30 and also below the necessary driving voltage value of the optical motion detector 11, the light of the light emitting unit 24a deservingly goes off, so the user can tell that the battery is dead.

What is claimed is:

1. A pointing device for controlling movement of a pointer displayed on a display unit of an information processing device, the pointing device comprising:
an emitting unit configured to emit light for controlling the movement of the pointer;
a battery; and
a control unit configured to control emission of light from the emitting unit with a first control method in an event that a remaining power of the battery exceeds a predetermined remaining amount, and to control emission of light from the emitting unit with a second control method in an event that the remaining power of the battery is below the predetermined remaining amount.

2. The pointing device according to claim 1, wherein, in the event that the remaining power of the battery is below the predetermined remaining amount, the control unit controls emission of light emitted from the emitting unit so as to perform one of blinking, turning off, and turning on.

3. A pointing device for controlling movement of a pointer displayed on a display unit of an information processing device, the pointing device comprising:
an emitting unit configured to emit light for controlling the movement of the pointer;
a communication unit configured to transmit, to the information processing device, signals indicating a movement amount of the pointer calculated based on the emitted light from the emitting unit;
a battery; and
a control unit configured to control emission of light from the emitting unit with a first control method in an event that a remaining power of the battery is such that the signals are transmitted from the communication unit to the information processing device, and controlling emission of light from the emitting unit with a second control method in an event that the remaining power of the battery is such that the signals are not transmitted from the communication unit to the information processing device.

4. The pointing device according to claim 3, wherein, in the event that the remaining power of the battery is such that the signals are not transmitted from the communication unit to the information processing device, the control unit controls emission of light emitted from the emitting unit so as to perform one of blinking, turning off, and turning on.

5. A battery remaining power display method of a pointing device having an emitting unit configured to emit light to control movement of a pointer displayed on a display unit of an information processing device, the method comprising the steps of:
determining a remaining power of a battery of the pointing device;
controlling emission of light from the emitting unit with a first control method in an event that determination is made in the determination step that the remaining power of the battery exceeds a predetermined remaining amount; and
controlling emission of light from the emitting unit with a second control method in an event that determination is made in the determination step that the remaining power of the battery is below the predetermined remaining amount.

6. The method according to claim 5, wherein the second control method is a method of controlling emission of light emitted from the emitting unit so as to perform one of blinking, turning off, and turning on.
